(19) United States
(12) Patent Application Publication
(10) Pub. No.: US 2010/0205542 A1
(43) Pub. Date: Aug. 12, 2010

(54) METHOD, SYSTEM FOR TRACKING GROUP BEHAVIOR

(76) Inventor: Christina Walman, Santa Barbara, CA (US)

Correspondence Address: Law Office of Wendell J. Jones, PMB 441, 555 Bryant Avenue, Palo Alto, CA, 94301, US

(21) Appl. No.: 12/538,105

(22) Filed: Aug. 7, 2009

Related U.S. Application Data
(60) Provisional application No. 61/087,137, filed on Aug. 7, 2008.

(51) Int. Cl. G06F 15/16; G06F 3/01

(52) U.S. Cl. 715/753; 709/204

(57) ABSTRACT

A method and system for keeping and tracking group behavior is disclosed. The system may provide notifications to users via mobile devices throughout the day prompting the users to engage in certain behaviors, such as performing a certain exercise or implementing a new food choice. The notification messages may be chosen depending on the group that the user belongs to. Upon completion of the action prompted by the notification, users of the group may reply to the notification indicating that they have completed the action. The responses may be tracked by the system for the purposes of reporting feedback to and providing for accountability for users and administrators of the system. The notifications may be designed to prompt behavior or actions that are brief, so that they may be completed during the course of the day.

### CROSS REFERENCE TO RELATED APPLICATION(S)

This application is related to and claims priority from U.S. Provisional Patent Application Ser. No. 61/087,137 filed Aug. 7, 2008.

### BACKGROUND

Current proposals exist to motivate individuals to engage in healthy behavior. Healthy behavior encompasses any type of behavior that results in good health, e.g. quitting smoking or drinking, exercising or working out at a gym, etc. With regard to exercise, for example, there are many reasons why an individual would rather exercise or workout at home than at a gym. For example, the requirement to conform to a rigorous schedule (such as the set by the gym) is reduced, gym membership and other costs are eliminated, and the individual can perform other chores, such as making dinner or doing laundry during the workout.

However, one negative aspect of not working out in a gym is that the individual will not be able to enjoy the camaraderie the gym setting provides. When the individual works out at home, the interaction and resulting motivation is not easily achieved. For example, working out alone in a home setting typically means that the individual will not have accountability to others of missing a workout to which the individual has committed. Further, an individual working out at home will not be able to see if his or her fellow classmates have worked out. What is needed is an effective way to address the issues noted above.

### SUMMARY OF INVENTION

The invention provides a method and system for keeping and tracking group behavior, exercises and workouts. Various aspects of the invention described herein may be applied to any of the particular applications set forth below. The invention may be applied as a standalone system or as a component of an integrated solution. The invention can be optionally integrated into existing business and processes seamlessly. It shall be understood that different aspects of the invention can be appreciated individually, collectively or in combination with each other.

In a first embodiment of the invention, a computer implemented method for tracking group behavior is disclosed. The computer implemented method comprises sending a notification to at least one user of a group wherein the notification specifies a behavior to be completed based on the user's membership in the group, receiving and storing responses from the user indicating completion of the behavior and providing feedback to the user based on the responses received from the group.

In a second embodiment of the invention, a computer readable storage medium is disclosed. The computer readable storage medium stores instructions that when executed by a computer cause the computer to perform a method for tracking group workouts, the method comprising sending a notification to at least one user of a group wherein the notification specifies a behavior to be completed based on the user's membership in the group, receiving and storing responses from the user indicating completion of the behavior and providing feedback to the user based on the responses received from the group.

In a third embodiment of the invention, a mobile workout system is disclosed. The system comprises a data storage component, a group membership module and a notifications module for sending a notification to at least one user of a group wherein the notification specifies a behavior to be completed based on the user's membership in the group, receiving and storing responses from the user indicating completion of the behavior and providing feedback to the user based on the responses received from the group.

In a fourth embodiment of the invention, a method of accessing a mobile workout system is disclosed. Accordingly, in a computer system having a graphical user interface including a display and a user interface selection device, the method of accessing a mobile workout system comprises providing an icon on the display, the icon representative of the mobile workout system, providing access to the mobile workout system via a network in response to selecting the icon wherein the mobile workout system further comprises a data storage component, a group membership module and a notifications module for sending a notification to at least one user of a group wherein the notification specifies a behavior to be completed based on the user's membership in the group, receiving and storing responses from the user indicating completion of the behavior and providing feedback to the user based on the responses received from the group.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

Some of the features of the invention are described as set forth in the following figures and description. A better understanding of the features and advantages of the invention will be obtained by reference to the following detailed description that sets forth illustrative embodiments provided in accordance with the invention.

FIG. 1 shows a mobile system that interacts with users and their mobile devices over a network.

FIG. 2 shows an example of a page of an interface that allows a user to sign up to use the system.

FIG. 3 shows an example of a page of an interface that allows a user to select a group to join.

FIG. 4 shows an example of a page of an interface that allows a user to select a group to join.

FIG. 5 shows an example of a page of an interface that allows a user to create a group or set a group's preferences.

FIG. 6 shows an example of notifications that a user may receive throughout the day.

### DETAILED DESCRIPTION OF INVENTION

In the following detailed description, numerous specific details are set forth in order to provide a thorough understanding of the invention. However it will be understood by those of ordinary skill in the art that the invention may be practiced without these specific details. In other instances, well-known methods, procedures, components and circuits have not been described in detail so as not to obscure the invention. Various modifications to the described embodiments will be apparent to those with skill in the art, and the general principles defined herein may be applied to other embodiments. The invention is not intended to be limited to the particular embodiments shown and described.

An aspect of the invention provides a user interface for keeping and tracking group behavior, exercises and workouts. The user interface may provide an online interface that allows members to have a shared workout or group experience and decrease the feeling of isolation when working out at home or the office, or trying to implement new behaviors individually. The interface may provide notifications to users throughout the day prompting them to perform specific exercises for brief periods of time, prompting them to make different food choices, prompting them to add meditation to their daily routine, or any other notification intended to modify or change a person's behavior. Thus, the notifications as discussed herein shall include any sort of notification that may prompt a user to engage in a certain type of behavior (e.g. exercise) or not engage in a certain type of behavior (e.g. smoking, drinking, gambling etc.).

Such change in behavior may be assisted through the support, motivation, and instruction that a group setting may provide. Upon completion of the exercise or behavior change, users may reply to the notification indicating that they have completed the exercise or behavior change. Responses may be tracked by the system for purposes of providing feedback to users and administrators of the system, such as reporting statistics or providing for accountability. The exercises or behavior changes may be designed to be brief or quickly accomplished, so that they may be easily completed during the course of the day. For example, a notification may prompt a user to complete a brief exercise which may take three minutes or less to complete.

In one embodiment, a method for tracking group workouts has a step of sending a notification to at least one user of a group. The notification may specify an exercise or behavioral change to be completed. The exercise or behavior may be based on the user's membership in the group. The user may respond to the notification to indicate completion of the exercise or behavioral change, and those responses may be received and stored. Based on the responses received from the accountability group, feedback, such as statistics, may be provided to the users. In one embodiment, the notification may be sent to a user's cellular telephone. In addition, the activity to be completed can be an exercise or behavioral change that is brief and that can be completed in a relatively short time period.

Unless specifically stated otherwise, as apparent from the following discussions, it is appreciated that throughout the specification, discussions utilizing terms such as “processing,” “computing, ” “calculating,” “determining,” or the like, may refer in whole or in part to the action and/or processes of a processor, computer or computing system, or similar electronic computing device, that manipulate and/or transform data represented as physical, such as electronic, quantities within the system's registers and/or memories into other data similarly represented as physical quantities within the system's memories, registers or other such information storage, transmission or display devices. It will also be appreciated by persons skilled in the art that the term “users” referred to herein can be individuals as well as corporations and other legal entities. Furthermore, the processes presented herein are not inherently related to any particular computer, processing device, article or other apparatus. An example of a structure for a variety of these systems will appear from the description below. In addition, embodiments of the present invention are not described with reference to any particular processor, programming language, machine code, etc. It will be appreciated that a variety of programming languages, machine codes, etc. may be used to implement the teachings of the invention as described herein.

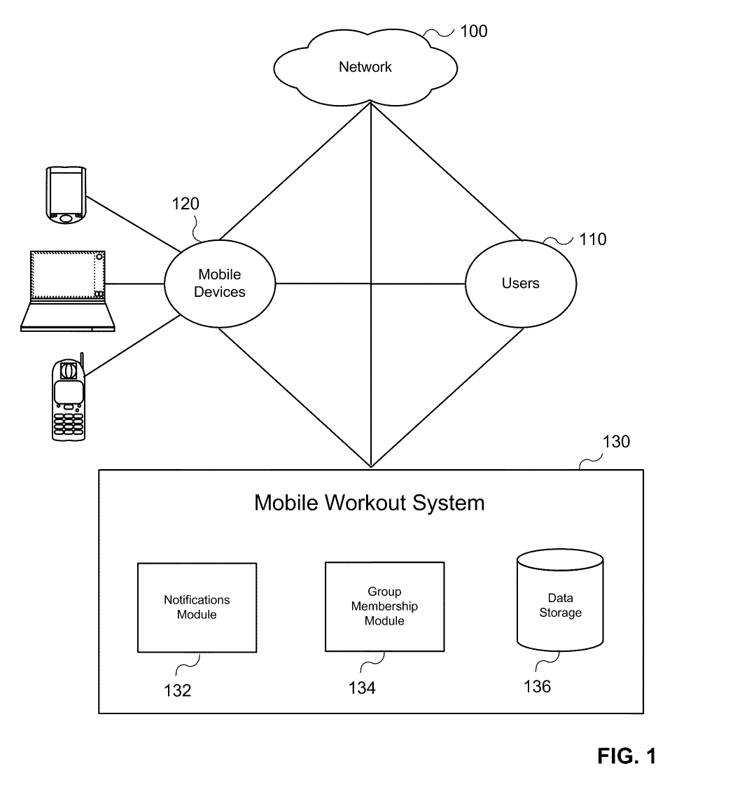

Referring to FIG. 1, a mobile workout system 130 may interact via a network 100 with various users 110 and mobile devices 120 of each of the users 110. The mobile workout system 130 may have a notifications module 132, which is used to send users 110 notifications which may prompt users 110 to perform specific exercises for brief periods of time. The notifications may also address a specific behavior, such as a notification to make a different food choice, add a period of meditation to the day, or address some other change in behavior of the recipient. These notifications may be received by users via their mobile devices 120. One skilled in the art can appreciate that the notification sent by the system and received by the user is not limited to the specific examples of such notifications discussed herein, but can include any form of communication sent to the user that may address the user's behavior or actions.

For example, an example of a notification may be sent as a text message to mobile device 120 that may be sent may contain the name of the exercise, such as “Lunge—1 minute”. The user may be able to find details about how to perform the exercise on a designated website online. Or alternatively, the user may be sent a video based notification, which would contain a video instruction of how to perform a certain exercise or implement a certain behavior. One skilled in the art will appreciate that mobile device 120 could include a graphical user interface including a display and a user interface selection device and may be any kind of mobile device including but not limited to a cell phone, (e.g. an iPhone) a PDA, or a laptop, and that the notifications are not limited to text messages but to any kind of notification sent to a mobile device 120. Further, one skilled in the art will recognize that the type of notification may include any type or medium of content such as text, video, sound, etc.

In one embodiment, each user 110 of a certain group may be sent notifications via a network 100 to a mobile device 120 according to the schedule defined by their group membership. Group memberships, the schedules, and any other group preferences may be managed by a group membership module 134. Users 110 that belong to the same group may be sent the same notifications, such that each group may, for example, go through a series of exercises in the system. Alternatively, a group's settings may be modified such that certain users receive some notifications and different users of the same group receive different notifications. For example, if two users are friends, then they may receive notifications to perform different exercises or behavioral changes, but they may belong to the same group for feedback or accountability purposes.

Upon completing an exercise or addressing a behavior or some other action, a user 110 may reply to the notification that they have received via the notifications module 132 to indicate to the system that they have completed the task sent by the notification. One method of replying is to simply reply via the user's mobile device 120 to the text message that contained the notification. These replies received by the system 130 may be stored by the system 130. A data storage 136, such as a database or some other form of storing data, may store information about users, group membership and preferences, as well as any replies received from the users 110 to the notifications. The replies could be blank or could provide an amount of an exercise accomplished. For example, “30 seconds static push up” or “drank juiced greens” or could just be the word “done”. The replies may be stored in the data storage 136 to provide feedback or statistics about the activities of users.

The group membership module 134 may also act as a scheduler for sending the notifications. The scheduler or notifications module 132 may send out notifications to users 110 at the appropriate time based on the schedule for the group to which they belong. The system 130 may also be enabled to receive responses from users 110 and store such responses in data storage 136. The mobile workout system 130 may store the time the response was received and the user identification from whom the response was received in data storage 136. Because groups can advance through the available notifications at different rates depending on their update schedule, the schedule or notifications module 132 may keep track of the last notifications sent to each group so that each group may have the opportunity to go through all of the notifications in order.

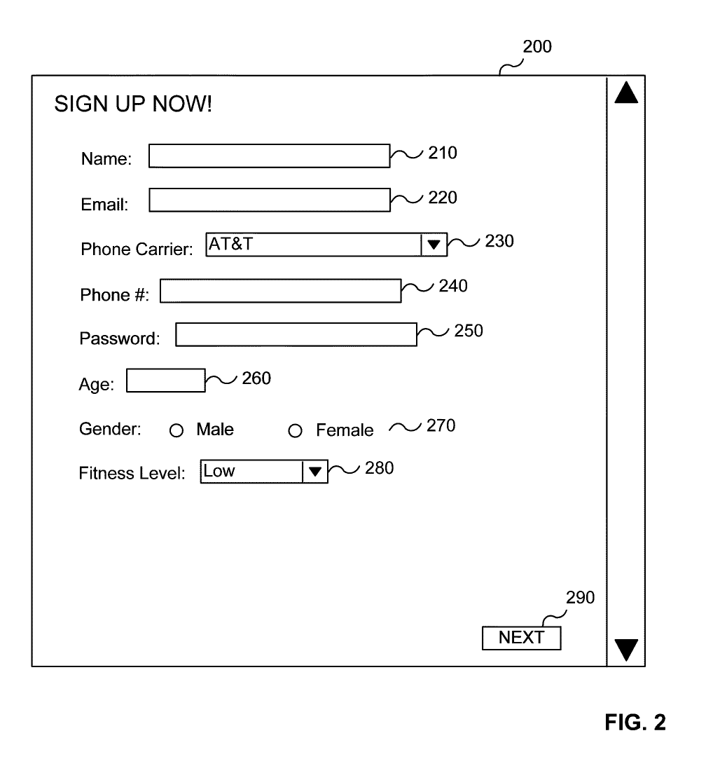

A user of the mobile workout system may sign up in order to receive notifications. FIG. 2 illustrates one example of a webpage 200 where users may sign up in order to receive notifications. The user may enter certain pieces of personal information such as: their name 210, email address 220, cell phone carrier 230, cell phone number 240, password 250, age 260, gender 270, fitness level 280, or other program goals or other preferences. Each of these pieces of data may be stored in data storage. In this example, a user may enter information in each of these fields, and then click next 290 to choose a group or create their own group. It will be appreciated that the invention is not limited to any of these particular fields or pieces of information, nor does it need to contain all of these fields. It will also be appreciated that the invention is not limited to using this webpage 200 to sign a user up to receive notifications, but any number of methods may be used.

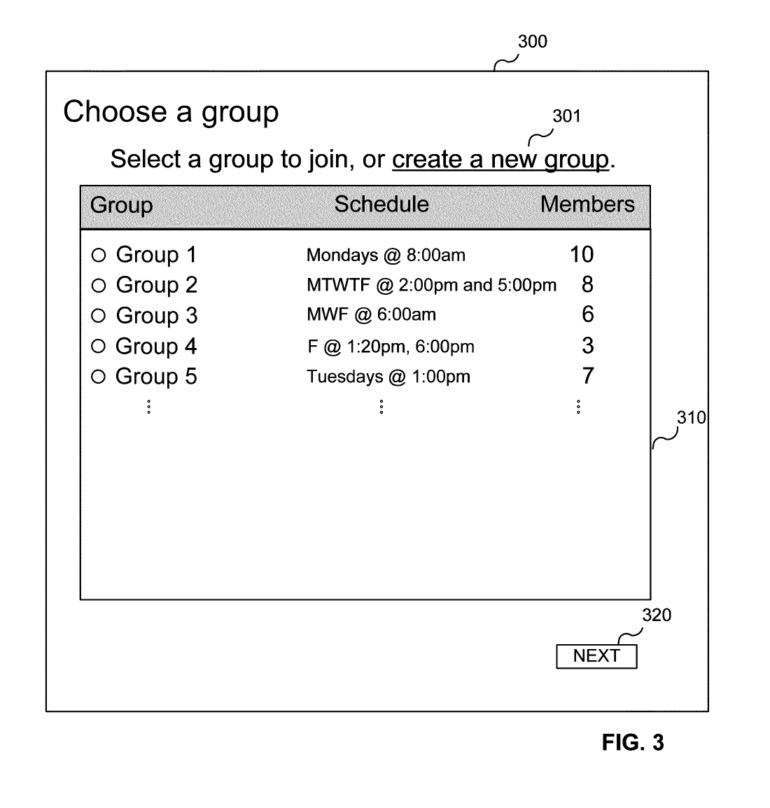

Referring to FIG. 3, when a user signs up to receive notifications, they may also select a group to join or create a new group. FIG. 3 shows one example of a webpage 300 that allows a user to select a group to join. Alternatively, a user may choose to create a new group via a link 301. The groups define the schedule of notifications that are sent for its members. A schedule may include the specific times of day that the notifications will be sent to the users in a group.

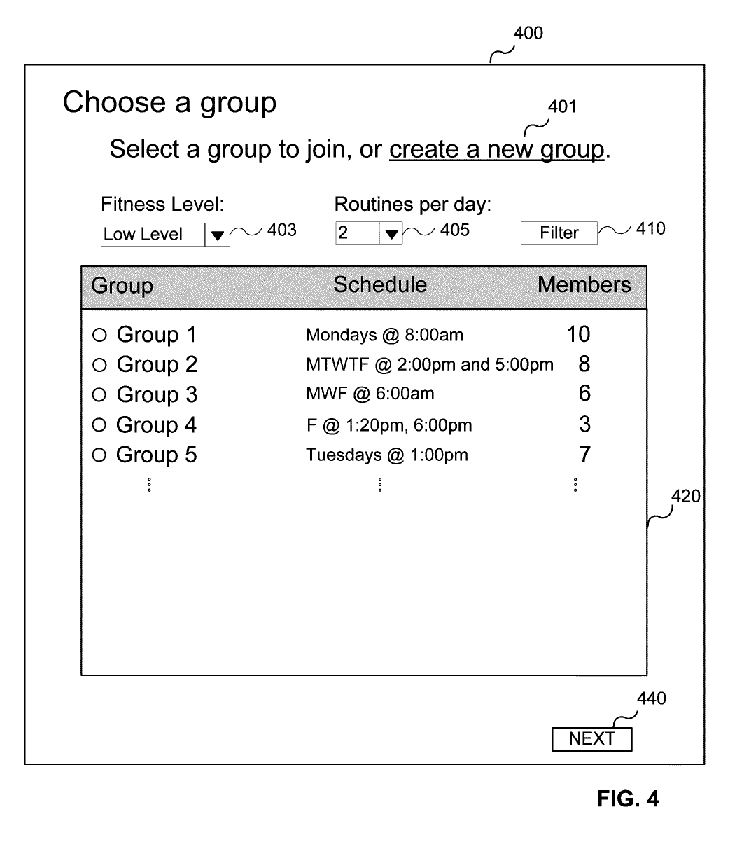

Referring to FIG. 4, in another example of a webpage that allows a user to select a group to join, the user may filter which groups they view via a series of filters, such as by their fitness level 403 or the number of routines or notifications that they would like to receive per day 405. A user may select options using these filters 403, 405 and then click on a filter button 410 in order to narrow the groups that are displayed in the box 420. The user may then select a group that they would like to join. One skilled in the art will appreciate that the invention is not limited to the specific filters or types of groups discussed herein.

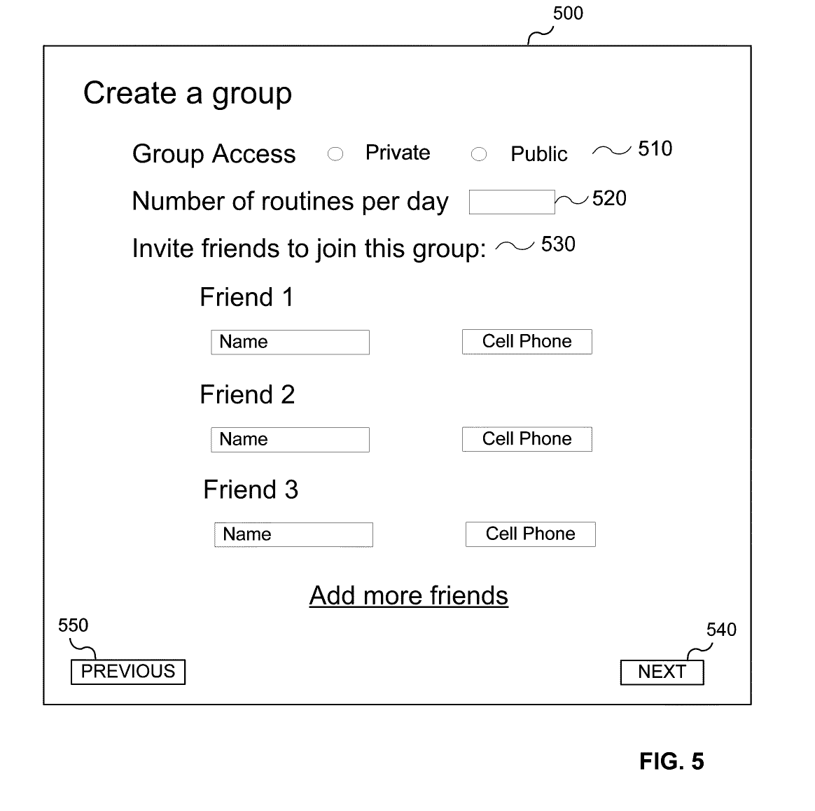

In FIG. 5, a user may alternatively create a group to define the notification schedule and the program content for its members. The group may have a unique group name and an update schedule. For example, an update schedule may have values such as: morning, afternoon, evening, or all day. In addition, the schedule may include specific times at which users receive notifications, including times of day and days of the week. These values may identify which times of day the user will receive notifications. The notifications may be customized by the group's manager or owner. A group may have any number of users or may limit the number of users that it may have.

In FIG. 5, the user may be able enter or set the group's preferences via several fields such as: group access 510, number of routines or notifications per day 520, and may invite friends to join the group 530. One skilled in the art will appreciate that the group's preferences are not limited to the foregoing fields, and a group's manager or any other group member may choose to customize other fields such as what notifications are sent and when.

Thus, the sign up process to sign up to receive notifications may be as follows: 1) click a sign up link on a designated web page; 2) enter personal information; and 3) join a group by selecting an existing group or creating a new one. Once the user has submitted the information, a confirmation email may be sent to the user to activate his or her account. Once the account has been activated, the user may be sent a sample notification. The notification may serve to introduce the user to the format of notifications and to test the user's ability to receive text messages via the mobile device.

If a user forgets his or her password, the user may have the option to reset the password. For example, users may be able to have a temporary password emailed to them so that they may log in and change their password. In addition, users may also update their account settings. Users may change any of their personal information. In order to increase security, the system may require confirmation from the user when changing his or her email address or phone number. Users may also change their group memberships or can create new groups. Users may also cancel their accounts.

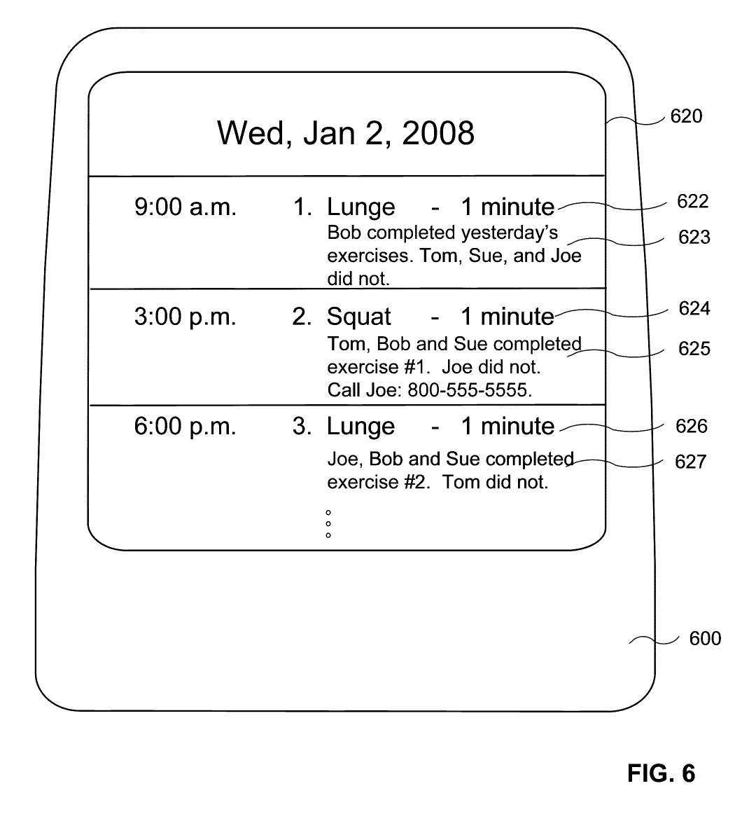

FIG. 6 shows an example of what a user's notifications may indicate. For example, a user's notifications may be received via their mobile device 620. The notification 622 may contain the name of an exercise, such as “Lunge—1 minute.” A notification may also be a video message, which shows a user how to perform a certain exercise or behavior. One skilled in the art can appreciate that the notification may be any kind of content that is delivered to the user on a certain schedule depending on the user's group memberships.

The notification may also indicate how many members of the group completed the previous exercises or behavioral changes. For example, the notification may state “9 of 10 members completed yesterday's exercises” as in 623 or “9 of 10 members completed exercise #1” as in 625. The notification may also specify which specific users in a group completed the exercise or behavioral change, such as “Tom, Joe and Laura completed the exercise and Bob did not.”

In one embodiment of the invention, the group memberships of certain users may facilitate communication and encouragement among group members to achieve certain behavior-related goals. For example, users may have a “buddy” or another group member of the same group, who will be prompted to contact the user if the user does not fulfill the action prompted by the notification. Thus, for example, in a certain group, Tom, Joe, Laura and Bob may all be members, and Tom and Laura are “buddies” or partners, and Joe and Bob are “buddies” or partners. If the notification specifies, “Tom, Joe and Laura completed the exercise and Bob did not,” then Joe may be prompted by the notification to call Bob to follow-up, provide encouragement, or some other motivation to engage in the action that the notification indicates.

In another embodiment of the invention, group members may receive different notifications, and receive feedback about the responses of their other accountability group members. For example, a user may receive feedback or statistical information about a friend or another member in the group, showing that they did or did not complete the actions prompted by the notification. In this manner, group members may be accountable to each other and may provide follow-up, support, encouragement, and motivation to each other to accomplish their goals, but each group member may customize his or her own goals to his or her own preferences, to receive different notifications.

Exercise descriptions or other types of descriptions may be made available through a designated website. For example, the notifications that are sent to user's mobile devices may indicate simply a name of an exercise, such as “Squat—1 minute”, “Side Stands—1 minute (each side)”, “Static Abs—1 minute”, “Pelvic Lift—1 minute (each leg), “Static Wall Push-Up—1 minute”, “Superman—1 minute”, “Powerwoman—1 minute”, “Lunge—1 minute (each leg).” Then, descriptions for each of these exercises may be found on a website. Some exercises may require users to be registered and logged in to view, or some samples may be provided for view for unregistered users who are investigating the website.

Administrators may be responsible for maintaining the system. They may have the ability to modify user account information or access the website. Administrators may also add, deactivate or change notifications in the schedules. Administrators may not receive notifications, and there may not be a sign up process for administrators.

In addition, administrators may also log in to an administrative interface on the website to edit a user's account and/or track the individual performance of the users. They may have access to the user's data, except for the user's password. They may have the ability to reset the password if necessary. Administrators may also have the ability to add and delete users and groups from the system and move users between groups. Administrators may also modify the notification schedule for a group and create programs made up of specific behaviors and/or tasks.

Administrators may add, modify or deactive notifications in a schedule. The administrators may modify the name, description, or an optional image of the behavioral notification. For exercises with statistical information associated with it, the system may allow the administrator to make any desired changes to the exercise information, but differentiate between feedback or statistics generated with the new notifications versus the statistics generated with the old notifications, by creating two different database entries or tables.

In some embodiments of the invention, the groups may be targeted towards certain goals—for example, a group may focus on exercises for back strengthening, and the exercise notifications may be focused on such exercises. The exercises or behavioral changes may depend on the preferences of the particular group.

All concepts of the invention may be incorporated and integrated with current virtual workout communities, including but not limited to those described in U.S. Patent Pub. No. 2005/0192156 A1 (Daikeler et al.) published on Sep. 1, 2005, which is hereby incorporated by reference in its entirety.

In all of the foregoing embodiments of the invention, it may not be necessary for any user to login to receive the notifications. In order to interact with a group, the user does not need to visit the website, but rather may simply receive notifications and send responses via their mobile device. Users of the same group, inherently then, may complete the same exercises or behavioral changes on a daily basis, to achieve their goals.

The above-described embodiment(s) may also be implemented, for example, by operating a computer system to execute a sequence of computer readable instructions. Accordingly, device 120 typically includes at least some form of computer readable media. Computer readable media can be any available media that can be accessed by device 120. By way of example, and not limitation, computer readable media may comprise computer storage media and communications media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage device, or any other medium which can be used to store the desired information and which can be accessed by device 120.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Accordingly, an alternate embodiment includes a computer readable storage medium storing instructions that when executed by a computer cause the computer to perform a method for tracking group behavior.

A method and system for keeping and tracking group behavior is disclosed. The system may provide notifications to users via mobile devices throughout the day prompting the users to engage in certain behaviors, such as performing a certain exercise or implementing a new food choice. The notification messages may be chosen depending on the group that the user belongs to. Upon completion of the action prompted by the notification, users of the group may reply to the notification indicating that they have completed the action. The responses may be tracked by the system for the purposes of reporting feedback to and providing for accountability for users and administrators of the system. The notifications may be designed to prompt behavior or actions that are brief, so that they may be completed during the course of the day.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A computer implemented method for tracking group behavior wherein the computer performs the following steps:
sending a notification to at least one user of a group wherein the notification specifies a behavior to be completed based on the user's membership in the group;
receiving and storing responses from the user indicating completion of the behavior; and
providing feedback to the user based on the responses received from the group.

2. The method of claim 1 wherein the behavior comprises an exercise.

3. The method of claim 1, wherein the notification is sent to a user's mobile device.

4. The method of claim 2, wherein the exercise to be completed can be completed in one minute or less.

5. The method of claim 1 wherein the notification is sent according to a schedule defined by the at least one user.

6. The method of claim 4 where the schedule includes specific times at which the at least one user receives the notification wherein the specific times comprise times of day and days of the week.

7. The method of claim 3 wherein the notification further comprises a video message which show the at least one user how to perform the behavior.

8. The method of claim 1 wherein the notification specifies which of the at least one user of the group completed the behavior.

9. The method of claim 8 wherein the notification comprises a prompt to one of the at least one user of the group to provide encouragement to another of the at least one user of the group.

10. The method of claim 1 wherein the feedback comprises statistical information about another of the at least one user of the group.

11. The method of claim 1 wherein the feedback comprises behavior statistic tracking and the method further comprises:
presenting the behavior statistic tracking based on the responses.

12. A computer readable storage medium storing instructions that when executed by a computer cause the computer to perform a method for tracking group behavior, the method comprising:
sending a notification to at least one user of a group wherein the notification specifies a behavior to be completed based on the user's membership in the group;
receiving and storing responses from the user indicating completion of the behavior; and
providing feedback to the user based on the responses received from the group.

13. The computer readable storage medium of claim 12 wherein the behavior comprises an exercise.

14. The computer readable storage medium of claim 12, wherein the notification is sent to a user's mobile device.

15. The computer readable storage medium of claim 13, wherein the exercise to be completed can be completed in one minute or less.

16. The computer readable storage medium of claim 12 wherein the notification is sent according to a schedule defined by the at least one user.

17. The computer readable storage medium of claim 15 where the schedule includes specific times at which the at least one user receives the notification wherein the specific times comprise times of day and days of the week.

18. The computer readable storage medium of claim 14 wherein the notification further comprises a video message which show the at least one user how to perform the behavior.

19. The computer readable storage medium of claim 12 wherein the notification specifies which of the at least one user of the group completed the behavior.

20. The computer readable storage medium of claim 19 wherein the notification comprises a prompt to one of the at least one user of the group to provide encouragement to another of the at least one user of the group.

21. The computer readable storage medium of claim 12 wherein the feedback comprises statistical information about another of the at least one user of the group.

22. The computer readable storage medium of claim 12 wherein the feedback comprises behavior statistic tracking and the method further comprises:
presenting the behavior statistic tracking based on the responses.

23. A mobile workout system comprising:
a data storage component;
a group membership module; and
a notifications module for:
sending a notification to at least one user of a group wherein the notification specifies a behavior to be completed based on the user's membership in the group;
receiving and storing responses from the user indicating completion of the behavior;
tracking accomplished behavior; and
providing feedback to the user based on the responses received from the group and the accomplished behavior.

24. The system of claim 23 wherein the behavior comprises an exercise.

25. The system of claim 23, wherein the notification is sent to a user's mobile device.

26. The system of claim 24, wherein the exercise to be completed can be completed in one minute or less.

27. The system of claim 23 wherein the notification is sent according to a schedule defined by the at least one user.

28. The system of claim 26 where the schedule includes specific times at which the at least one user receives the notification wherein the specific times comprise times of day and days of the week.

29. The system of claim 27 wherein the notification further comprises a video message which show the at least one user how to perform the behavior.

30. The system of claim 23 wherein the notification specifies which of the at least one user of the group completed the behavior.

31. The system of claim 30 wherein the notification comprises a prompt to one of the at least one user of the group to provide encouragement to another of the at least one user of the group.

32. The system of claim 23 wherein the feedback comprises statistical information about another of the at least one user of the group.

33. The system of claim 23 wherein the feedback comprises behavior statistic tracking and the notifications module presents the behavior statistic tracking based on the responses.

34. In a computer system having a graphical user interface including a display and a user interface selection device, a method of accessing a mobile workout system comprising:
providing an icon on the display, the icon representative of the mobile workout system;
providing access to the mobile workout system via a network in response to selecting the icon wherein the mobile workout system further comprises a data storage component;
a group membership module; and
a notifications module for:
sending a notification to at least one user of a group wherein the notification specifies a behavior to be completed based on the user's membership in the group;
receiving and storing responses from the user indicating completion of the behavior;
tracking accomplished behavior; and
providing feedback to the user based on the responses received from the group and the accomplished behavior.

35. The method of claim 34 wherein the behavior comprises an exercise.

36. The method of claim 34, wherein the notification is sent to a user's mobile device.

37. The method of claim 35, wherein the exercise to be completed can be completed in one minute or less.

38. The method of claim 34 wherein the notification is sent according to a schedule defined by the at least one user.

39. The method of claim 37 where the schedule includes specific times at which the at least one user receives the notification wherein the specific times comprise times of day and days of the week.

40. The method of claim 36 wherein the notification further comprises a video message which show the at least one user how to perform the behavior.

41. The method of claim 34 wherein the notification specifies which of the at least one user of the group completed the behavior.

42. The method of claim 41 wherein the notification comprises a prompt to one of the at least one user of the group to provide encouragement to another of the at least one user of the group.

43. The method of claim 34 wherein the feedback comprises statistical information about another of the at least one user of the group.

44. The method of claim 34 wherein the feedback comprises behavior statistic tracking and the method further comprises:
presenting the behavior statistic tracking based on the responses.
